(19) United States
(12) Patent Application Publication
(10) Pub. No.: US 2016/0297016 A1
(43) Pub. Date: Oct. 13, 2016

(54) MECHANICAL TOOL WITH SUPPORT STRUCTURE

(71) Applicant: Florida Power & Light Company, Juno Beach, FL (US)

(72) Inventors: David M. White, Sunrise, FL (US); Teodoro Gonzalez, Pembroke Pines, FL (US)

(73) Assignee: Florida Power & Light Company, Juno Beach, FL (US)

(21) Appl. No.: 15/095,704

(22) Filed: Apr. 11, 2016

Related U.S. Application Data
(60) Provisional application No. 62/145,269, filed on Apr. 9, 2015.

(51) Int. Cl. B23D 45/00; B25H 1/00; B23D 45/02

(52) U.S. Cl. CPC B23D 45/006; B23D 45/028; B25H 1/0064

(57) ABSTRACT

A structure modification system may include a structure attachment portion secured to a structure, an articulating arm connected to the structure attachment portion, and a mechanical tool connected to the articulating arm. The mechanical tool may be a saw and the structure may be a vertically oriented pole or column. The structure attachment portion may be secured to the structure with one or more straps, which may wrap around the structure. The articulating arm may include first and second arm segments which may pivot with respect to one another. The operation of the system may allow for a horizontal cut of the structure by the saw from any side of the structure.

### CROSS REFERENCE TO RELATED APPLICATIONS

This application claims priority to U.S. Provisional Patent Application No. 62/145,269 filed on Apr. 9, 2015, the entire contents of which are herein incorporated by reference.

### FIELD OF THE DISCLOSURE

This disclosure relates generally to mechanical tools, such as saws, and structures for the same, particularly as used for the removal or modification of structures such as posts, poles, and columns.

### BACKGROUND

Mechanically powered saws are one of several tools utilized for the removal, destruction, or modification of structural components such as posts, poles, or columns. In the context of utility poles, such as those supporting above-ground electrical lines, these poles are on average forty (40) feet tall and made from dense material such as wood or concrete. A powerful mechanical saw is necessary in order to cut-down these utility poles. Such a saw is likely to be to heavy or bulky which may render it difficult for a worker to operate by simply holding the saw. Moreover, holding a heavy or bulky mechanical saw is a safety hazard given the potential for the worker to drop or otherwise mishandle the saw. Also problematic is that it is difficult, if not impossible, for a worker to execute a controlled, planar cut of the structure with the mechanical saw. Due to the heaviness or the bulkiness of the tool, a worker may unintentionally adjust the height or angle of the saw during mid-cut. The result is often an uneven cut with an unintentional angle to the cut which may cause the utility pole to fall at an unintended angle, resulting in yet another safety hazard to the worker, particularly if the saw blades are fractured. Accordingly, a new and improved system is desirable for mechanical tooling utilized in the removal or modification of a variety of structures including utility poles.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one embodiment of the disclosure, a structure modification system may be attached to a structure and used to modify the structure, and the system may include a structure attachment portion attachable to the structure, an articulating arm connectable to the structure attachment portion, and a mechanical tool connectable to the articulating arm, the connected mechanical tool orientable to a variety of positions with respect to the structure. In another embodiment, the system may include a structure attachment portion including a body, a first structure connecting segment projecting away from the body, a second structure connecting segment projecting away from the body, the first and second structure connecting segments forming a gap, a first strap connector and a second strap connector each including a pair of strap connector walls and a rivet extending between the strap connector walls, and a strap fixed to the rivet of the first strap connector and releasably secured to the second strap connector by wrapping the strap around the structure. The system may further include an articulating arm, which may include an elongate first arm segment having a proximate end and a distal end, the proximate end connectable with the structure attachment portion, an elongate second arm segment having a proximate end and a distal end, the proximate of the second arm segment pivotably connectable with the distal end of the first arm segment, the first and second arm segments pivotable with respect to each other about a pivot arm axis, and a tool connector provided at or proximate to the distal end of the second arm segment. The system may further include a mechanical tool connected to the tool connector. In another embodiment of the disclosure, a method for modifying a structure with a mechanical tool may include attaching a structure attachment portion of a structure modification system to an outer surface of the structure, connecting an articulating arm to the structure attachment portion, securing the mechanical tool to an opposing end of the articulating arm, and operating the mechanical tool to modify the structure at different sides of the structure.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a side view of an embodiment of a structure attachment portion of a structure modification system;

FIG. 2 illustrates a side view of an embodiment of an articulating arm of a structure modification system;

FIG. 3 illustrates a perspective view of the structure attachment portion of FIG. 1 connected with the articulating arm of FIG. 2, and the structure attachment portion is attached to a structure, and a mechanical tool is attached to the articulating arm;

FIG. 4 illustrates a top perspective view of an another embodiment of a structure modification system;

FIG. 5 illustrates a first perspective view of an embodiment of a mechanical tool as it is attached to an embodiment of an articulating arm; and

FIG. 6 illustrates a perspective view of an embodiment of a mechanical tool connected with an embodiment of an articulating arm.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

In this document, the terms “a” or “an” are used, as is common in patent documents, to include one or more than one. In this document, the term “or” is used to refer to a nonexclusive or, unless otherwise indicated. Furthermore, references to “one embodiment” or “an embodiment” are not intended to be interpreted as explicitly excluding the existence of additional embodiments that also incorporate the recited features. Moreover, unless explicitly stated to the contrary, embodiments “comprising,” “including,” or “having” an element or a plurality of elements having a particular property may include additional such elements not having that property.

In one embodiment of the disclosure, a structure modification system may be attached to a structure and used to modify the structure, and the system may include a structure attachment portion attachable to the structure, an articulating arm connectable to the structure attachment portion, and a mechanical tool connectable to the articulating arm, the connected mechanical tool orientable to a variety of positions with respect to the structure. The mechanical tool may be a saw oriented to administer a cut across the structure, and the variety of positions may include every side of the structure. The structure attachment portion may include a body and a pair of structure connecting segments projecting from the body, and the structure connecting segments may press against an outer surface of the structure. The structure attachment portion may include a strap connector and a strap connected to the strap connector, and the strap may provide a force for pressing the structure connecting segments against the outer surface of the structure. The structure attachment portion may include an additional strap connector, and the strap may wrap around the structure and connect to the additional strap connector. The structure attachment portion may include an upper pair of strap connectors, a lower pair of strap connectors, and a pair of straps, and each strap may be connected to one of the strap connectors in a pair and wrappable around the structure so as to releasably connect to the other strap connector in the pair. The structure attachment portion may include a connection channel and a structure attachment portion handle which opens the connection channel as it is pulled and closes the connection channel as it is pressed, and the articulating arm may include a structure attachment connector which is insertable into the open connection channel, and the inserted structure attachment connector is secured within the closed connection channel. The structure attachment portion may include a first arm segment connector, and the articulating arm includes a structure attachment connector which is connectable to the first arm segment connector. The structure attachment portion may include a body, a first structure connecting segment projecting away from the body, a second structure connecting segment projecting away from the body, the first and second structure connecting segments forming a gap, a first strap connector and a second strap connector each including a pair of strap connector walls and a rivet extending between the strap connector walls, a strap fixed to the rivet of the first strap connector and releasably securable to the second strap connector by wrapping the strap around the structure, a pair of ribs provided on the body, and a connection channel provided between the ribs, the connection channel manipulable between an open position and a closed position. The articulating arm may include a structure attachment connector which is insertable into the open connection channel, and the inserted structure attachment connector is secured within the closed connection channel, tightening the wrapped-around strap results in the first and second structure connecting segments to be pressed against an outer surface of the structure, and the structure may be a pole or column. The structure attachment portion may further include a third strap connector and a fourth strap connector each projecting away from the body, the third and fourth strap connectors each including a pair of strap connector walls and a rivet connecting between the strap connector walls, and an additional strap fixed to the third strap connector and releasably securable to the fourth strap connector by wrapping the strap around the structure, where the pair of ribs and the connection channel may be positioned between the first and second strap connectors and the third and fourth strap connectors. The articulating arm may include an elongate first arm segment having a proximate end and a distal end, and an elongate second arm segment having a proximate end and a distal end, the distal end of the first arm segment may be pivotably connected to the proximate end of the second arm segment, and the proximate end of the first arm segment may be pivotably connected with the structure attachment portion. The articulating arm may include a tool connector at or proximate to the distal end of the second arm segment, and the mechanical tool may be connectable with the tool connector. The mechanical tool may include a tool holder having a base platform and an arm connector projecting from the base platform, and the arm connector of the mechanical tool may be connectable with the tool connector.

In another embodiment of the disclosure, a method for modifying a structure with a mechanical tool may include attaching a structure attachment portion of a structure modification system to an outer surface of the structure, connecting an articulating arm to the structure attachment portion, securing the mechanical tool to an opposing end of the articulating arm, and operating the mechanical tool to modify the structure at different sides of the structure. The articulating arm may include a first arm segment pivotably connected with a second arm segment, the first arm segment connected to the structure attachment portion and the second arm segment connected with the mechanical tool. The attaching may include wrapping a strap around the structure. The attaching may further include utilizing the strap to urge the structure attachment portion against an outer surface of the structure. The structure may be a substantially vertically oriented pole or column and the mechanical tool may be a saw, and the operating may further include positioning the saw to any side of the structure and administering a substantially horizontal cut to the structure.

In another embodiment, the system may include a structure attachment portion including a body, a first structure connecting segment projecting away from the body, a second structure connecting segment projecting away from the body, the first and second structure connecting segments forming a gap, a first strap connector and a second strap connector each including a pair of strap connector walls and a rivet extending between the strap connector walls, and a strap fixed to the rivet of the first strap connector and releasably secured to the second strap connector by wrapping the strap around the structure. The system may further include an articulating arm, which may include an elongate first arm segment having a proximate end and a distal end, the proximate end connectable with the structure attachment portion, an elongate second arm segment having a proximate end and a distal end, the proximate of the second arm segment pivotably connectable with the distal end of the first arm segment, the first and second arm segments pivotable with respect to each other about a pivot arm axis, and a tool connector provided at or proximate to the distal end of the second arm segment. The system may further include a mechanical tool connected to the tool connector. The mechanical tool may be a saw and the structure may be a substantially vertically oriented pole or column, and the connected saw may be movable to any and every side of the pole or column and operable to administer a substantially horizontal cut across the pole of column.

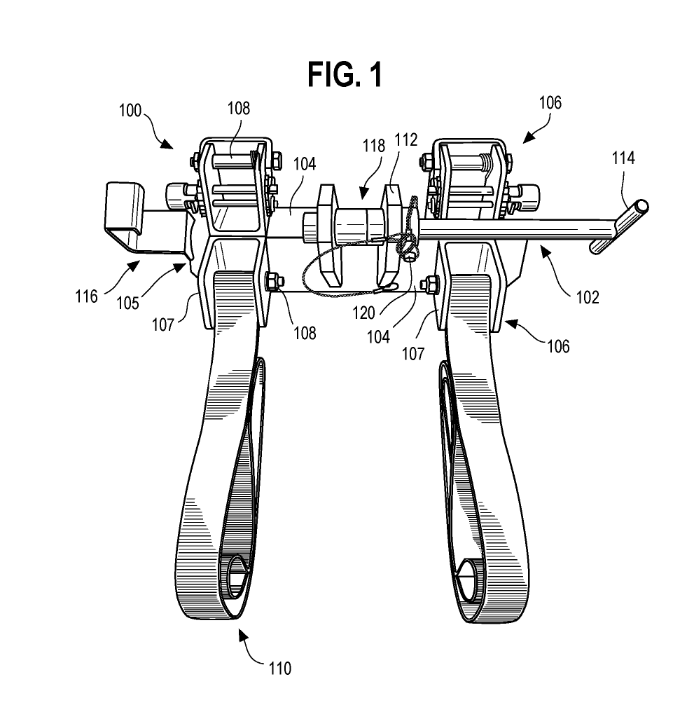

FIGS. 1-3 show an embodiment of a structure modification system 10 which may include a structure attachment portion 100, an articulating arm 200, and a mechanical tool 300. With reference initially to FIG. 1, a structure attachment portion 100 may include a body 102, one or more structure connecting segments 104, and one or more strap connectors 106. In the illustrated embodiment, a pair of structure connecting segments 104 are illustrated, which may be referred herein as first and second structure connecting segments. The structure connecting segments 104 may be walls or panels projecting away from body 102. A gap 105 may be defined in between each structure connecting segment 102, and gap 105 may have an angle or curvature in order to accommodate the curvature of the structure 20. For instance, the illustrated embodiment shows structure attachment portion 100 secured to a concrete column which has a substantially rectangular cross section with substantially right-angled corners. In this embodiment, gap 105 may form an approximately 90 degree angle in order to conform to the outer surface of structure 20. In some embodiments, this angle may be adjustable in order to accommodate a variety of structural formations. One such modification may be to permit the structure connecting segments 104 to be pivotable to accommodate wider or narrower angles. Another contemplated modification is providing structure connecting segments 104 with malleable or elastic material so as to accommodate structures having curved outer surfaces, such as a pole or column. A further modification could be an insert (not illustrated) positioned within gap 105, with the insert having a curvature in order to accommodate an outer surface curvature of a structure. An additional modification may be to adjust the distal ends of the structure connecting segments 104, such as including a lining, attachment, or performing another adjustment which permits at least the distal ends to contact a variety of outer surfaces of a structure, including curved or irregular surfaces, as well as possibly surfaces which have low friction and are susceptible to slippage. It should be understood and appreciated that one or more of these modifications may be separately and independently incorporated, as well as possibly conjunctively or combination thereof, in order to create a tight and strong connection between structure attachment portion 100 and the outer surface of structure 20.

Strap connectors 106 may be provided on an opposite side of body 102, which would position strap connectors 106 as projecting away from structure 20 when the structure attachment portion is secured to the structure. As shown in the illustrated embodiment, four strap connectors 106 may be provided including an upper pair of strap connectors and a lower pair of strap connectors. Each pair of strap connectors 106 may include a first strap connector and a second strap connector. Each strap connector 106 may include a plurality of strap connector walls 107, including for instance an upper and lower strap connector wall. A rivet or bolt 108 may be provided between each upper and lower strap connector wall 107. A strap 110 may be secured to one or more strap connectors 106. For instance, a strap 110 may be permanently secured to a rivet 108 of a first strap connector 106, then wrapped around structure 20, and releasably secured to a rivet of a second strap connector. The releasable securing of strap 110 to second strap connector may occur from tying the strap, utilizing a buckle with the strap, or any other known or to be discovered method for securing a strap. Straps 110 do not necessarily need to be wrapped around structure 20. In another embodiment, each strap connector 106 may be connected with an end of a strap 110, and each strap may be tied or secured to a secure or stable surface other than structure 20. For instance, the straps 110 could be tied to a wall or vehicle which may be positioned such that securing of the straps results in a force exerted by the straps against the structure 20 thereby tightly securing structure attachment portion 100 against the outer surface of the structure. The illustrated embodiment shows four strap connectors 106 and two straps 110, however a person of ordinary skill in the art would be able to modify the dimensions of body 102 so as to accommodate more or fewer strap connectors 106 as so desired.

Body 102 may also be provided one or more reinforcement ribs 112, which may be included in order to increase the stability of body 102 and, more particularly, structure connecting segments 104. Ribs 112 may be placed laterally across body 102 in order to increase the stability from forces exerted against structure connecting segments 104 as structure attachment portion 100 is forcibly secured against structure 20. Two ribs 112 are illustrated, however structure attachment portion 100 may be modified to include greater or fewer ribs as would be desired by a person of ordinary skill in the art. A handle 114 may also be provided in order to assist a technician or operator of the system 10 in his or her maneuvering of structure attachment portion 100. In one embodiment, handle 112 projects longitudinally from body 102. A shelf 116 may also be provided. The shelf may be designed and dimensioned to hold one or more objects, such as the operator's tools, during the installation of system 10. In the illustrated embodiment, shelf 116 is depicted as attached the longitudinal end of body 102 opposite from handle 114. While a person of ordinary skill in the art may contemplate an alternative location for shelf 116, as well as the possible addition of a second or third shelf in certain embodiments, positioning shelf 116 at a longitudinal end permits storage of objects while minimizing the shelf's interference with the operation and securing of structure attachment portion 100.

In order to provide for a connection between structure attachment portion 100 and articulating arm 200, a connection channel 118 may be provided which me be transitionable between and open and a closed position, for instance through articulation of handle 114. In the illustrated embodiment, connection channel 118 is shown in a closed position, however handle 114 may be pulled so as to create a space within body 102 which may dimensionally accommodate a portion of articulating arm 200, as described further herein. In the illustrated embodiment, connection channel 118 is provided between two ribs 112. Moreover, a connection channel lock 120 may be provided in order to maintain connection channel 118 in either an open position or a closed position. In the illustrated embodiment, connection channel lock 120 includes a removable pin which inserts into a portion of body 102 which is slidable between the open and closed positions. The end of the slidable portion of body 102 may include handle 114, which is provided for pulling or pushing the slidable portion of body 102 in a longitudinal direction, thereby changing the state of connection channel 118 between open and closed.

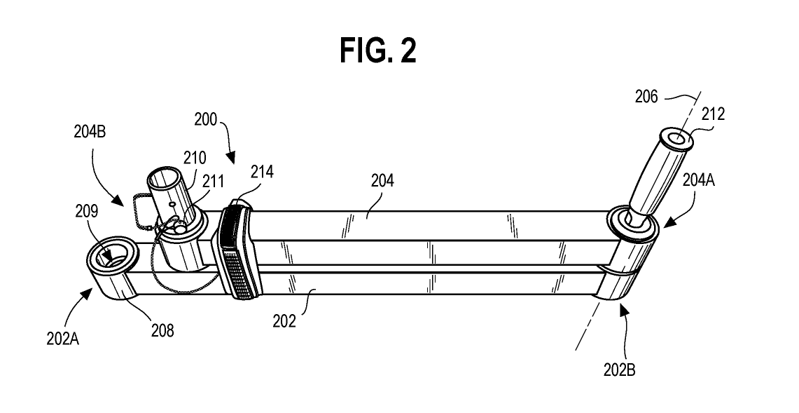

FIG. 2 shows an embodiment of articulating arm 200 in a stored position. Articulating arm may include a proximate or first arm segment 202 and a distal or second arm segment 204 pivotably attached to the first arm segment. Each arm segment 202, 204 may be substantially elongate, and accordingly a first or proximate end 202A, 204A and a second or distal end 202B, 204B may be defined on opposing ends of each arm segment. The distal end 202B of the first arm segment 202 may be pivotably connected with the proximate end 204A of the second arm segment 204 such that the arm segments may rotate with respect to each other about a pivot arm axis 206. Some embodiments may permit a full 360 degree rotation about pivot arm axis 206.

Provided at or near proximate end 202A of the first segment 202 may be a structure attachment connector 208 for connecting articulating arm 200 with structure attachment portion 100. Structure attachment connector 208 may have a substantially circular cross section with arm connector passage 209 defined through the interior of structure attachment connector 208. Structure attachment connector 208 may be dimensioned to fit within connection channel 118 when the connection channel is in the open position. As connection channel is transitioned to the closed position, by pushing on handle 114 for instance, a portion of slidable portion of body 102 may slide into connector passage 209, resulting in a secure connection that permits first arm segment 202 to pivot with respect to structure attachment portion 100.

At or proximate to the distal end 204B of second arm segment 204 may be a tool connector 210, which may be utilized to connect second arm segment 204 with a mechanical tool 300. In one embodiment, tool connector 210 may be a cylindrical projection for insertion into, or engagement with, a portion of mechanical tool 300 as shown and described herein. A tool connector lock 211 may be provided to secure the connection with tool connector 210 and mechanical tool 300. In the illustrated embodiment, tool connector lock 211 includes a pin insertable within a portion of tool connector 210, similar to the illustrated embodiment of connection channel lock 120.

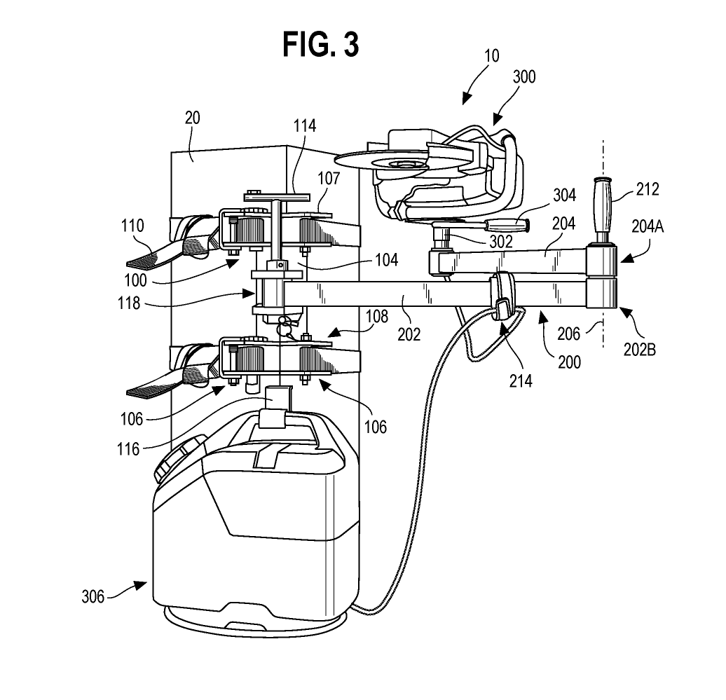

An arm handle 212 may also be provided in order to assist an operator of system 10 with the manipulation of articulating arm 200. In the illustrated embodiment, handle 212 is a projection provided substantially along arm pivot axis 206. While other points of attachment of handle 212 are contemplated within the disclosure, the illustrated positioning provides a central leverage point from which an operator can efficiently control the positioning of both arm segments 202, 204. Handle 212 may have a high friction coating or covering, such as a rubber cover, in order to improve an operator's grip on handle 212. A sleeve or band 214 may also be provided. Sleeve 214 may wrap around first and second arm segments 202, 204 when they are longitudinally parallel in a stored position, such as illustrated in FIG. 2. Sleeve 214 may also be utilized for organization of objects utilized with system 10, such as securing a hose as shown in FIG. 3.

FIG. 3 shows structure removal system 10 with structure attachment portion 100 attached to a structure 20, articulating arm 200 connected with structure attachment portion 100, and mechanical tool 300 connected with the articulating arm 200. As shown in the illustrated embodiment, mechanical tool 300 may be a mechanical saw utilized for the cutting of structure 20. It should be understood and appreciated that other types of tools for cutting, drilling, manipulating, destroying, adjusting, moving, or otherwise interacting with structure 20 as well as possibly an area adjacent to structure 20. Non-limiting examples of mechanical tool 300 may include motorized saws, hand saws, laser cutters, drills, cranes, and other known or to be discovered tooling. Because mechanical tool 300 may be detachable from system 10, tool 300 may for instance be a hand-held saw when detached or unmounted from arm 200. Accordingly, tool 300 may be used in a hand held mode of operation when unmounted from arm 200 or in a guided mode of operation by system 10, at the discretion of the operator at the time of operation.

Mechanical tool 300 may include an arm connector 302 which may engage with tool connector 210. In one embodiment, arm connector 302 and tool connector 210 may be conformingly dimensioned cylindrical projections, with one having a smaller diameter than the other such that one may slide into the other and be locked in place with tool connector lock 211, which may be pin mutually insertable through both tool connector 210 and arm connector 302 when they are joined. Tool connector lock 211 may be utilized to prevent the disjoining of tool 300 from second arm segment 204. In another embodiment, arm connector 302 may be a passage or opening which tool connector 210 is insertable into. A tool handle 304 may also be provided in order to facilitate the movement of tool 300. Depending on the type of tool utilized as part of system 10, tool objects 306 may be utilized as part of the tool 300, and shelf 116 may be utilized to hold one or more tool objects 306. In the illustrated embodiment, a tank of fuel or coolant is contemplated as one such tool object 306 which may hang by the tank's handle on shelf 116. In embodiments where a fluid connection is required between tool object 306 and tool 300, by a hose or line for instance, band 214 may be utilized to secure the hose or line to one of the arm segments 202, 204. As should be appreciated from the disclosure, assembly of system 10 in the field should be relatively quick and easy for an operator. Given the relatively few connection or attachment points between attachment portion 100, arm 200, and tool 300, an operator should be able to easily and quickly assemble and use system 10 in the field. For example, attachment portion 100 may be first attached to structure 20, arm 200 may be placed atop the attachment portion and secured, and tool 300 may be placed atop arm 200 and secured. As should be appreciated particularly from FIGS. 1 and 2, components of system 10 may be collapsible and easily portable, which may permit easy transportation particularly where system 10 is required to be attached to a highly elevated portion of structure 20. Indeed, structure 20 could be well over one hundred feet tall, and tool 300 may be required for at a considerable height. Accordingly, a user of system 10 could collapse the system and easily transport it to the required elevation, such as in the basket of a boom arm.. Furthermore, the operator may easily assemble the system at the height of operation while in the basket and utilized tool 300 from any angle or position around structure 20.

As should be appreciated, system 10 provides a variety of pivot points in order to move tool 300 into a variety of orientations with respect to structure 20 while maintaining a rigid or invariant attachment point between system 10 and structure 20, namely at attachment portion 100. Tool 300 may accordingly be positioned on any side of structure 20 without reattachment or reconfiguration of structure attachment portion 100. A variety of dimensions of system 10 are contemplated, particularly for instance the lengths of arm segments 202, 204, in order to accomplish the possible 360 degree orientation of tool 300 with respect to structure 20. Accordingly, tool 300 as used as part of system 10 may administer a stable, planar cut of structure 20. In one embodiment, tool 300 administers a perpendicular cut or a horizontal cut when the structure is vertical. As part of system 10, this cutting may occur from any side of the structure, providing a 360 degree orientation of tool 300 all the while it is attached to structure 20 at a single point or section via structure attachment portion 100. However, a substantially planar cut from tool 300 in accordance with the disclosure would still constitute an improvement over utilizing tool 300 without the rest of system 10. This is particularly true with respect to safety concerns of workers operating tool 300, which may be safely secured to structure 20 as part of system 10. Additional arm segments 202, 204 are contemplated within the disclosure, however it should be appreciated that two arm segments provide a sufficient range of mobility to permit orientation of tool 300 onto any side of structure 30 where the structure is a pole or column.

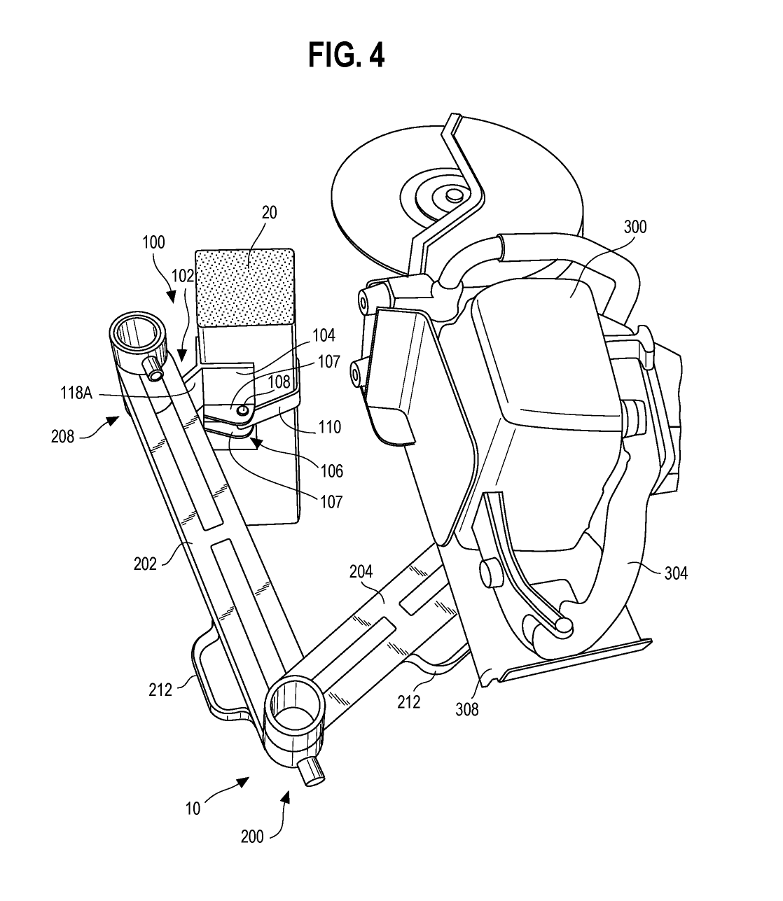

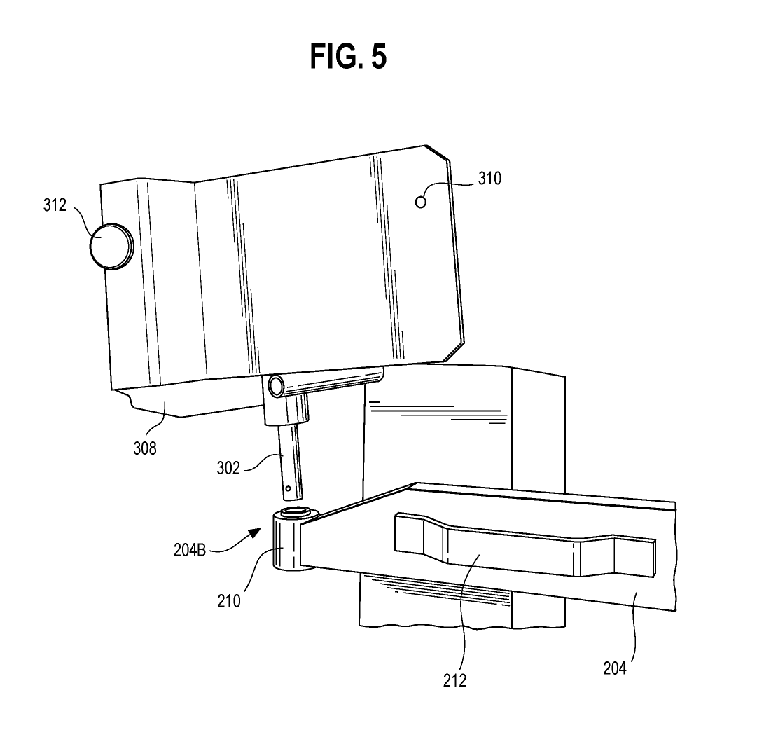

With reference now to FIGS. 4-6, another embodiment of system 10 is shown. Attachment portion 100 may include a pair of structure connecting segments 104 designed to be pressed against structure 20 at a first or front surface of structure connecting segments 104, while one or more strap connectors 106 are provided on a second or rear surface of structure connecting segment. In this embodiment, a pair of strap connector walls 107 may be provided on the rear surface of structure connecting segments 104, with a rivet 108 provided between the connector walls. Strap 110 may then be connected about rivet 108.

In lieu of a connection channel 118, a first arm segment connector 118A may be provided for pivotably connecting structure attachment portion 100 with first arm segment 202. First arm segment connector 118A may be provided in a portion of body 102 projected away from structure connecting segments 104 and strap connectors 106. In such an embodiment, first arm segment connector 118A may be a cylindrical projection insertable into connector passage 209. Also shown in this embodiment are a plurality of arm handles 212, one attached to each arm segment 202, 204.

A tool holder 308 may be provided in order to support or stabilize mechanical tool 300 as it is connected to articulating arm 200. Tool holder 308 may include a base wall or platform, and one or more side walls. In the illustrated embodiment, a side wall of tool holder 308 includes a plurality of tool holder apertures 308, which may accommodate a tool holder connector 312 for securing mechanical tool 300 with tool holder 308. For instance, tool holder apertures 310 may be internally threaded, and tool holder connector 312 may feature mateable threading with tool holder apertures 310 as well as a portion of mechanical tool 300. Apertures 310 and tool holder connectors 312 may also be provided on the platform of tool holder 308. The platform may also include the arm connector 302, which may be insertable within tool connector 210 of articulating arm 200.

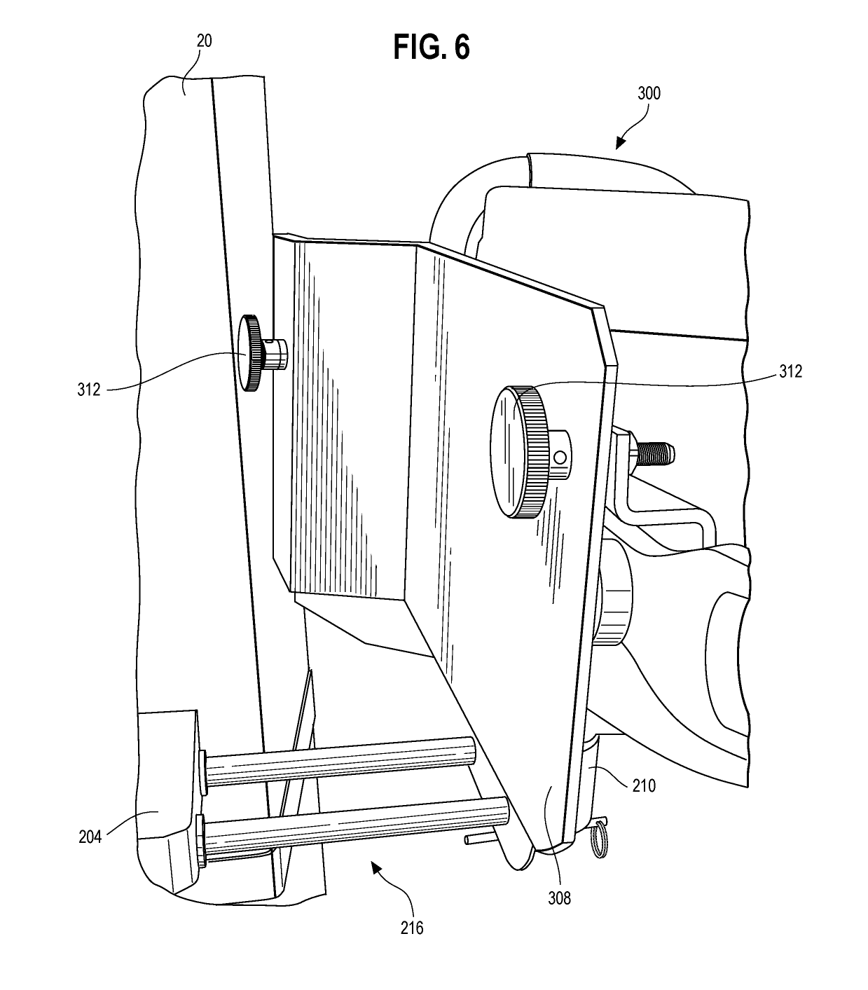

In some embodiments, arm segments 202, 204 may have adjustable lengths in order to accommodate additional positions of mechanical tool 300 as part of system 10. For instance, FIG. 6 shows an embodiment of an arm segment extender 216 on second arm segment 204. In this embodiment, arm segment extender includes a plurality of cylindrical extensions which are slidable within the interior of second arm segment 204. By longitudinally sliding arm segment extender 216, the distal end 204B of the second arm segment 204 is re-positioned thereby increasing the length of second arm segment 204.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

### LISTING OF CLAIM ELEMENTS

10—Structure Modification System
20—Structure
100—Structure Attachment Portion
102—Body
104—Structure Connecting Segments
105—Gap
106—Strap Connectors
107—Strap Connector Wall
108—Rivet
110—Strap
112—Reinforcement Rib
114—Structure Attachment Portion Handle
116—Shelf
118—Connection Channel
118A—First Arm Segment Connector
120—Connection Channel Lock
200—Articulating Arm
202—First Arm Segment
202A—Proximate End of First Arm Segment
202B—Distal End of First Arm Segment
204—Second Arm Segment
204A—Proximate End of Second Arm Segment
204B—Distal End of Second Arm Segment
206—Pivot Arm Axis
208—Structure Attachment Connector
209—Connector Passage
210—Tool Connector
211—Tool Connector Lock
212—Ann Handle
214—Band
216—Ann Segment Extender
300—Mechanical Tool
302—Ann Connector
304—Tool Handle
306—Tool Object
308—Tool Holder
310—Tool Holder Aperture
312—Tool Holder Connector

What is claimed:

1. A structure modification system attachable to a structure and used to modify the structure, the system comprising:
a structure attachment portion attachable to the structure;
an articulating arm connectable to the structure attachment portion; and
a mechanical tool connectable to the articulating arm, the connected mechanical tool orientable to a variety of positions with respect to the structure.

2. The structure modification system of claim 1, wherein the mechanical tool is a saw oriented to administer a cut across the structure, and
wherein the variety of positions include every side of the structure.

3. The structure modification system of claim 1, wherein the structure attachment portion includes a body and a pair of structure connecting segments projecting from the body,
wherein the structure connecting segments press against an outer surface of the structure.

4. The structure modification system of claim 3, wherein the structure attachment portion further includes a strap connector and a strap connected to the strap connector,
wherein the strap provides a force for pressing the structure connecting segments against the outer surface of the structure.

5. The structure modification system of claim 4, wherein the structure attachment portion further includes an additional strap connector,
wherein the strap can wrap around the structure and connect to the additional strap connector.

6. The structure modification system of claim 3, wherein the structure attachment portion includes an upper pair of strap connectors, a lower pair of strap connectors, and a pair of straps,
wherein each strap is connected to one of the strap connectors in a pair and is wrappable around the structure so as to releasably connect to the other strap connector in the pair.

7. The structure modification system of claim 3, wherein the structure attachment portion includes a connection channel and a structure attachment portion handle which opens the connection channel as it is pulled and closes the connection channel as it is pressed, and
wherein the articulating arm includes a structure attachment connector which is insertable into the open connection channel, and the inserted structure attachment connector is secured within the closed connection channel.

8. The structure modification system of claim 3, wherein the structure attachment portion includes a first arm segment connector, and
wherein the articulating arm includes a structure attachment connector which is connectable to the first arm segment connector.

9. The structure modification system of claim 2, wherein the structure attachment portion includes
a body,
a first structure connecting segment projecting away from the body,
a second structure connecting segment projecting away from the body, the first and second structure connecting segments forming a gap,
a first strap connector and a second strap connector each including a pair of strap connector walls and a rivet extending between the strap connector walls,
a strap fixed to the rivet of the first strap connector and releasably securable to the second strap connector by wrapping the strap around the structure,
a pair of ribs provided on the body, and
a connection channel provided between the ribs, the connection channel manipulable between an open position and a closed position,
wherein the articulating arm includes a structure attachment connector which is insertable into the open connection channel, and the inserted structure attachment connector is secured within the closed connection channel,
wherein tightening the wrapped-around strap results in the first and second structure connecting segments to be pressed against an outer surface of the structure, and
wherein the structure is a pole or column.

10. The structure modification system of claim 9, wherein the structure attachment portion further includes
a third strap connector and a fourth strap connector each projecting away from the body, the third and fourth strap connectors each including a pair of strap connector walls and a rivet connecting between the strap connector walls, and
an additional strap fixed to the third strap connector and releasably securable to the fourth strap connector by wrapping the strap around the structure,
wherein the pair of ribs and the connection channel are positioned between the first and second strap connectors and the third and fourth strap connectors.

11. The structure modification system of claim 2, wherein the articulating arm includes an elongate first arm segment having a proximate end and a distal end, and an elongate second arm segment having a proximate end and a distal end,
wherein the distal end of the first arm segment is pivotably connected to the proximate end of the second arm segment, and
wherein the proximate end of the first arm segment is pivotably connected with the structure attachment portion.

12. The structure modification system of claim 11, wherein the first and second arm segments pivot with respect to one another about a pivot arm axis, and the articulating arm includes a handle provided along the pivot arm axis.

13. The structure modification system of claim 11, wherein the articulating arm includes a tool connector at or proximate to the distal end of the second arm segment,
wherein the mechanical tool is connectable with the tool connector.

14. The structure modification system of claim 13, wherein the mechanical tool includes a tool holder having a base platform and an arm connector projecting from the base platform,
wherein the arm connector of the mechanical tool is connectable with the tool connector.

15. A method for modifying a structure with a mechanical tool, the method comprising:
attaching a structure attachment portion of a structure modification system to an outer surface of the structure;
connecting an articulating arm to the structure attachment portion;
securing the mechanical tool to an opposing end of the articulating arm; and
operating the mechanical tool to modify the structure at different sides of the structure.

16. The method of claim 15, wherein the articulating arm includes a first arm segment pivotably connected with a second arm segment, the first arm segment connected to the structure attachment portion and the second arm segment connected with the mechanical tool.

17. The method of claim 15, wherein the attaching comprises wrapping a strap around the structure.

18. The method of claim 15, wherein the structure is a substantially vertically oriented pole or column and the mechanical tool is a saw, and
wherein the operating further includes positioning the saw to any side of the structure and administering a substantially horizontal cut to the structure.

19. A structure modification system attachable to a structure and used to modify the structure, the system comprising:
a structure attachment portion including
a body,
a first structure connecting segment projecting away from the body,
a second structure connecting segment projecting away from the body, the first and second structure connecting segments forming a gap,
a first strap connector and a second strap connector each including a pair of strap connector walls and a rivet extending between the strap connector walls, and
a strap fixed to the rivet of the first strap connector and releasably secured to the second strap connector by wrapping the strap around the structure;
an articulating arm including
an elongate first arm segment having a proximate end and a distal end, the proximate end connectable with the structure attachment portion,
an elongate second arm segment having a proximate end and a distal end, the proximate of the second arm segment pivotably connectable with the distal end of the first arm segment, the first and second arm segments pivotable with respect to each other about a pivot arm axis, and
a tool connector provided at or proximate to the distal end of the second arm segment; and
a mechanical tool connected to the tool connector.

20. The structure modification system of claim 19, wherein the mechanical tool is a saw and the structure is a substantially vertically oriented pole or column, and
wherein the connected saw is movable to every side of the pole or column and operable to administer a substantially horizontal cut across the pole of column.
